(19) United States
(12) Patent Application Publication
(10) Pub. No.: US 2014/0050245 A1
(43) Pub. Date: Feb. 20, 2014

(54) THERMAL PROTECTION OF ROTATING COMPONENTS IN FUEL-VAPOR ZONES

(71) Applicants: Wayne R. Spock, Canton, CT (US); Charles J. McColgan, West Granby, CT (US)

(72) Inventors: Wayne R. Spock, Canton, CT (US); Charles J. McColgan, West Granby, CT (US)

(73) Assignee: HAMILTON SUNDSTRAND CORPORATION, Windsor Locks, CT (US)

(21) Appl. No.: 13/589,230

(22) Filed: Aug. 20, 2012

(51) Int. Cl. G01N 25/72

(52) U.S. Cl. CPC G01N 25/72
USPC 374/4

(57) ABSTRACT

A system for monitoring a rotating component in a fuel-vapor zone includes a housing of the rotating component in contact with the fuel-vapor zone; at least one temperature sensor in contact with an outer surface of the housing, wherein the at least one temperature sensor monitors a temperature of the outer surface of the housing and provides an indication when the temperature exceeds a selected temperature; and a controller connected to the at least one temperature sensor to receive the indication, wherein the controller terminates operation of the rotating component upon receipt of the indication.

### BACKGROUND

The present invention is related to component monitoring, and in particular to a system and method for providing thermal protection for rotating components in fuel-vapor zones.

Rotating aircraft components, such as those in motor driven compressors, are susceptible to high surface temperatures at the component housings during certain failure modes of the rotating components. The surfaces of these housings may be located within fuel-vapor zones. The surface temperatures in contact with fuel-vapors must remain below an ignition threshold so as to avoid ignition of the vapors. This requires that during normal operation, and during any failure modes, component surface temperatures remain below the ignition threshold.

Some failure modes in rotating engine components, such as failures at bearing rub surfaces in a motor driven compressor, may generate temperatures beyond those allowed by FAA and aircraft guidelines. These failures can initiate at internal points within the rotating components where protection devices cannot be installed, or signals cannot be read externally. Therefore, it is desirable to provide a system for detecting these internal failures so that failure modes may be handled prior to component surface temperatures reaching an ignition threshold within fuel-vapor zones.

### SUMMARY

A system for monitoring a rotating component in a fuel-vapor zone includes a housing of the rotating component, at least one temperature sensor, and a controller. The housing is in contact with the fuel-vapor zone. The at least one temperature sensor that is in contact with an outer surface of the housing monitors a temperature of the outer surface of the housing and provides an indication when the temperature exceeds a selected temperature. The controller is connected to the at least one temperature sensor to receive the indication of excess temperature, and terminates operation of the rotating component upon receipt of the indication.

### BRIEF DESCRIPTION OF THE DRAWINGS

FIG. 1 is a block diagram illustrating a system for monitoring a rotating aircraft component according to an embodiment of the present invention.

FIG. 2 is a schematic diagram of a motor driven compressor (MDC) according to an embodiment of the present invention.

FIG. 3 is a schematic diagram of a modeled component housing for an MDC according to an embodiment of the present invention.

FIG. 4 is a schematic diagram of a housing for an MDC showing a location of attached temperature sensors according to an embodiment of the present invention.

FIG. 5 is a schematic diagram of a temperature sensor bonded to a component housing according to an embodiment of the present invention.

FIG. 6 is a flowchart illustrating a method of determining a location for at least one sensor on the surface of a component according to an embodiment of the present invention.

FIG. 7 is a flowchart illustrating a method of monitoring a surface temperature of a rotating aircraft component according to an embodiment of the present invention.

### DETAILED DESCRIPTION

The present invention describes a system and method for providing thermal protection for rotating components in fuel-vapor zones. A thermal path is analytically determined from an initiation site of a failure to the surface of a housing of the rotating component using a housing model. Optimum locations for thermal sensors on the surface of the component are determined by performing a thermal analysis on the housing model. The sensors are bonded to the surface of the component at the optimum locations and monitor the surface temperature of the component during normal system operation. If the surface temperature reaches a selected temperature, the sensors provide an indication to a controller. Action may then be taken, such as the controller terminating operation of the rotating component.

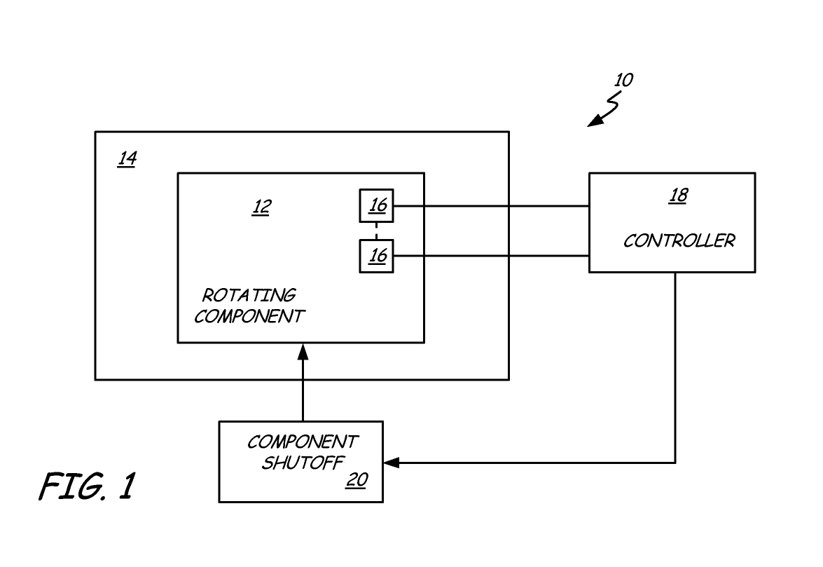

FIG. 1 is a block diagram illustrating a system 10 for monitoring a rotating component 12 of an aircraft within a fuel-vapor zone 14. Rotating component 12 is any component of an aircraft with rotating components, such as a motor driven compressor (MDC). Sensors 16 are connected to a housing surface of component 12 to monitor the surface temperature of component 12. Sensors 16 are any sensors capable of measuring a temperature, such as thermal switches, thermocouples, resistive temperature devices (RTDs), or any other known devices. Sensors 16 are connected to communicate with controller 18 and indicate to controller 18 when the surface temperature of component 12 reaches a selected temperature, such as approximately 435° F. The selected temperature is typically lower than the ignition limit of the vapors in fuel-vapor zone 14. In one non-limiting embodiment, the communication between sensors 16 and controller 18 may be accomplished using a wired connection. In other embodiments, sensors 16 may communicate with controller 18 wirelessly using, for example, radio-frequency (RF) transceivers or any other devices capable of wireless communication. Once sensors 16 indicate the surface temperature has reached the selected temperature, controller 18 shuts down rotating component 12 through shutoff module 20. Shutoff module 20 may be part of engine controller 18, or may be a separate mechanical component. The selected temperature is selected to allow enough time for rotating component 12 to be shut down such that the surface temperature of component 12 never reaches an ignition threshold that would cause ignition of the vapors within fuel-vapor zone 14. Controller 18 is any electronic controller of a rotating aircraft component, such as an electric motor control. The number of sensors 16 included in the system 10 may be determined, for example, using safety level requirements combined with a failure rate of a single sensor 16.

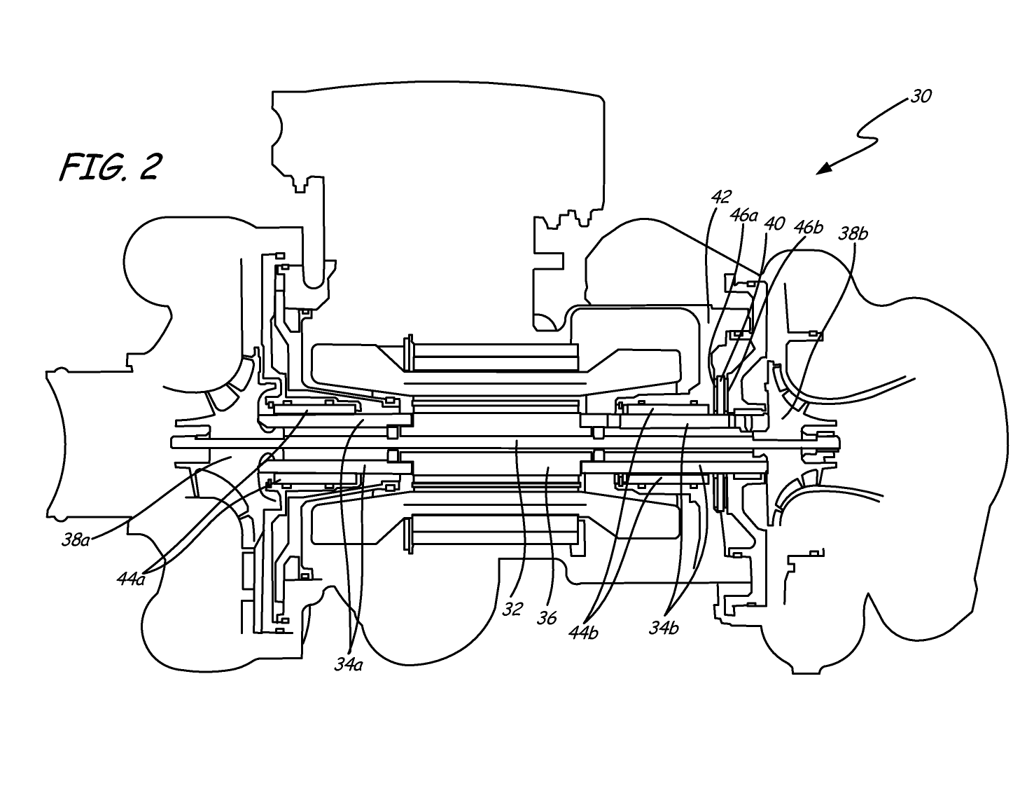

FIG. 2 is a schematic diagram of MDC 30 according to an embodiment of the present invention. MDC 30 includes tie rod 32, motor shafts 34a and 34b, stator winding 36, rotor compressor stages 38a and 38b, thrust runner 40, housing 42, journal bearings 44a and 44b, and thrust bearings 46a and 46b. In one non-limiting embodiment, stator winding 36 drives compressor stages 38a and 38b. In other embodiments, the rotating component may be driven by any rotating machine, such as a turbine. Motor shafts 34a and 34b rotate on journal bearings 44a and 44b. Thrust runner 40 is utilized to prevent axial movement of the rotating components of MDC 30. Thrust bearings 46a and 46b prevent contact between thrust runner 40 and housing 42. Failure modes can occur, for example, due to failures of any of bearings 44a, 44b, 46a and 46b. When a failure occurs at thrust bearing 46b, for example, heat is generated due to contact between thrust runner 40 and housing 42. This heat is conducted to the surface of housing 42 which can create temperatures above normal operating temperatures.

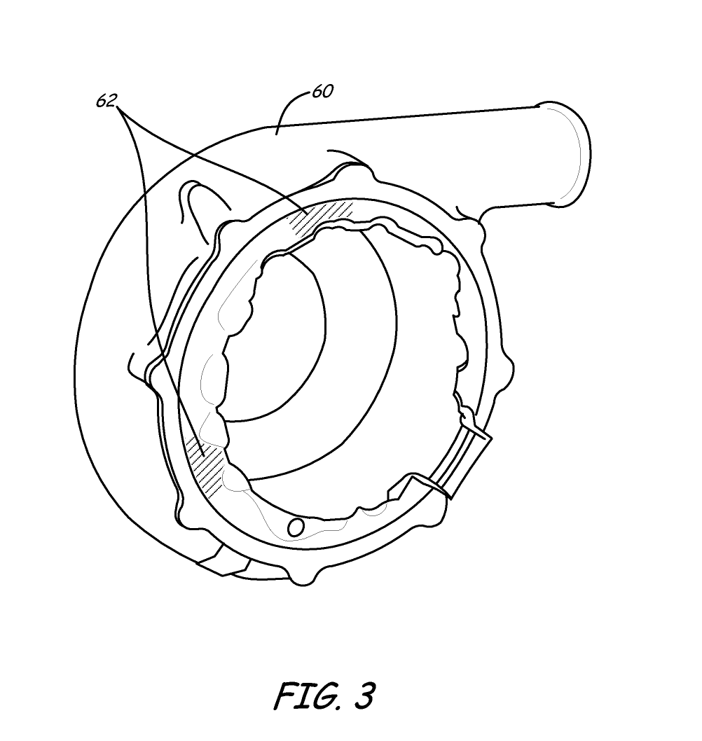

FIG. 3 is a schematic diagram of modeled component housing 60 according to an embodiment of the present invention. Modeled component housing 60 is a thermal model that corresponds to housing 42 of MDC 30 (FIG. 2). Modeled component housing 60 is generated using a housing model, such as a finite element model (FEM). Thermal analysis using, for example, computational fluid dynamics (CFD) is performed on the FEM to generate modeled component housing 60. Modeled component housing 60 includes thermal indicators 62 that indicate the sections of modeled component housing 60 that heat up to the greatest temperatures over the shortest period of time. Thermal indicators 62 are utilized to obtain the ideal locations to place temperature sensors.

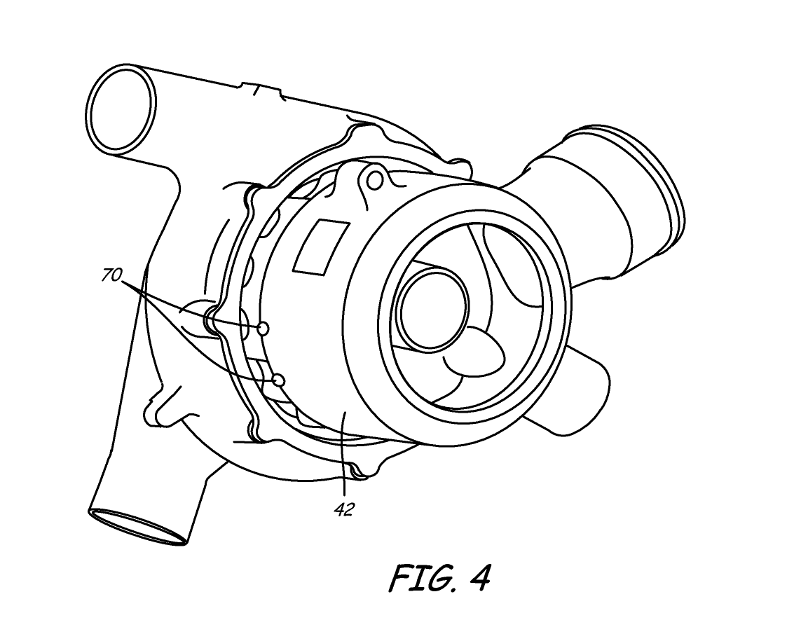

FIG. 4 is a schematic diagram of housing 42 showing locations of temperature sensors 70 according to an embodiment of the present invention. Temperature sensors 70 are placed on housing 42 based upon the temperature profile obtained using modeled component housing 60 (FIG. 3). Sensors 70 are any thermal sensors capable of measuring a surface temperature of housing 42 such as thermal switches, thermocouples, resistive temperature devices (RTDs), or any other known devices. In one non-limiting example, if using thermal switches, sensors 70 remain closed during normal system operation. If the temperature of housing 42 reaches a selected temperature, sensors 70 open, indicating to controller 18 (FIG. 1) that MDC 30 (FIG. 2) should be shut down.

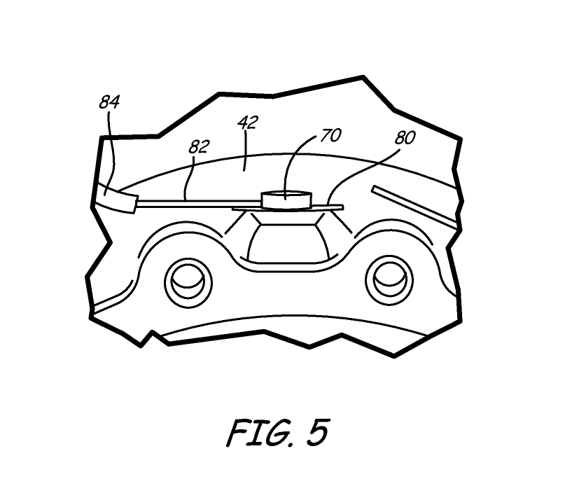

FIG. 5 is a schematic diagram illustrating one of the plurality of temperature sensors 70 bonded to component housing 42 according to an embodiment of the present invention. Flat 80 is machined on housing 42 to accommodate sensor 70. Wire 82 connects sensor 70 with controller 18 (FIG. 1). To avoid chafing, wire 82 may be encapsulated in wire wrap 84. In one embodiment, sensor 70 is bonded to flat 80 using any known suitable bonding agent. However, other suitable ways may be utilized to connect sensor 70 to flat 80 without departing from the scope of the invention.

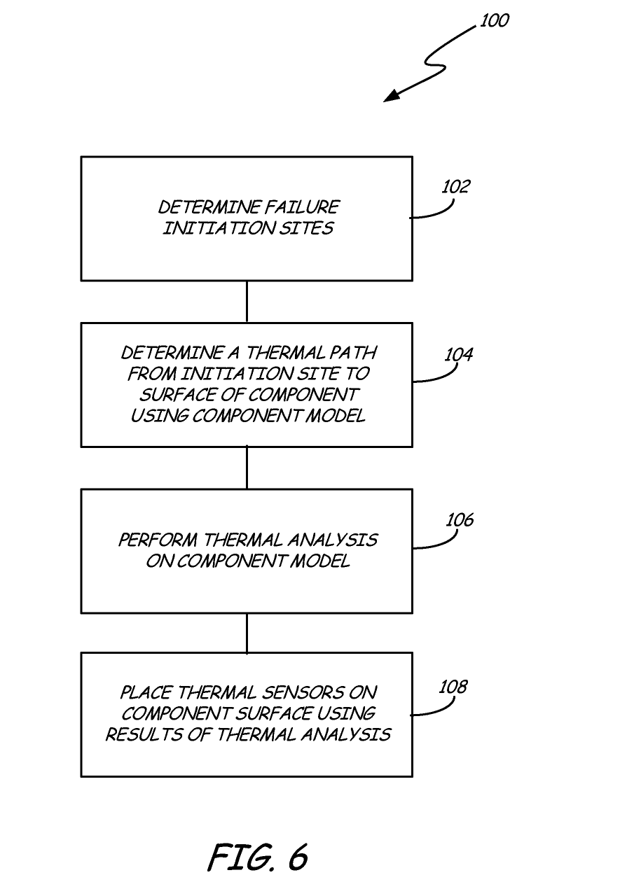

FIG. 6 is a flowchart illustrating method 100 of determining a location of sensors 70 on the surface of a component according to an embodiment of the present invention. At step 102, failure initiation sites are determined using a housing model, known failure sites, or other known method of determining initiation sites for failure modes. At step 104, a housing model, such as a finite element model, is used to determine a thermal path from the initiation sites to a surface of the component. At step 106, thermal analysis is performed on the housing model to determine locations on the surface of the component that reach the greatest temperatures over the shortest period of time using, for example, computational fluid dynamics. At step 108, thermal sensors are attached to these locations for use during normal system operation.

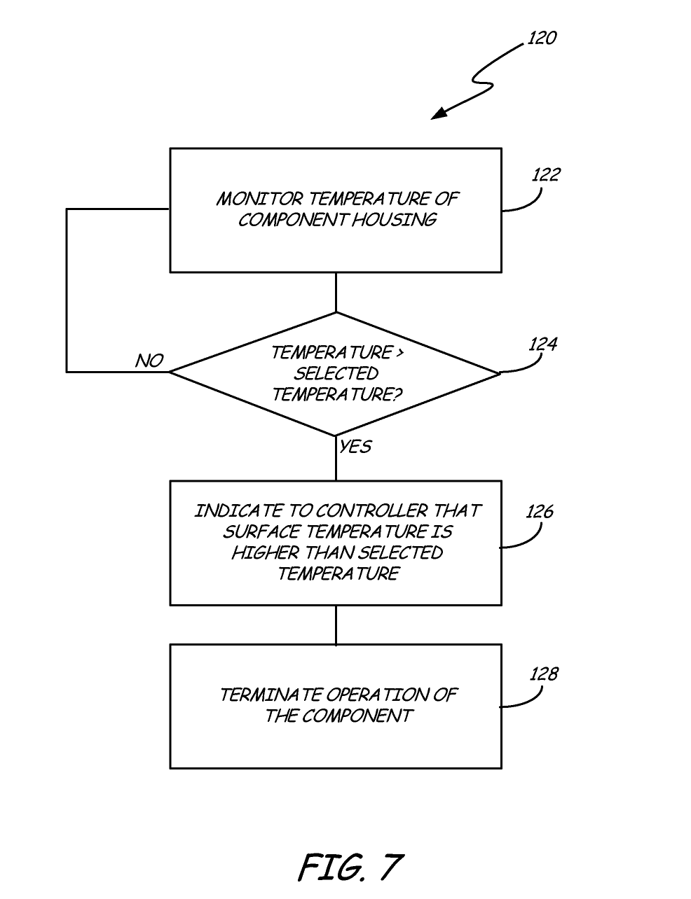

FIG. 7 is a flowchart illustrating method 120 of monitoring a surface temperature of a component of an engine according to an embodiment of the present invention. At step 122, sensors 70 monitor the temperature of component housing 42. At step 124, it is determined if the temperature measured at step 122 is greater than a selected temperature. This selected temperature is selected to allow enough time for the component to be shut down so that the surface temperature of the component never reaches an ignition threshold that would cause ignition of the vapors within a fuel-vapor zone. If the temperature is greater than the predefined temperature, method 120 proceeds to step 126. If the temperature is less than the predefined temperature, method 120 returns to step 122. At step 126, sensors 70 indicate that the surface temperature is greater than the predefined temperature to controller 18. At step 128, controller 18 shuts down the component.

In this way, the present invention describes a system and method for determining a thermal path for detection of failure modes in gas turbine engine components. Although the present invention has been described with reference to preferred embodiments, workers skilled in the art will recognize that changes may be made in form and detail without departing from the spirit and scope of the invention.

1. A system for monitoring a rotating component in a fuel-vapor zone, the system comprising:
a housing of the rotating component in contact with the fuel-vapor zone;
at least one temperature sensor in contact with an outer surface of the housing, wherein the at least one temperature sensor monitors a temperature of the outer surface of the housing and provides an indication when the temperature exceeds a selected temperature; and
a controller connected to the at least one temperature sensor to receive the indication, wherein the controller terminates operation of the rotating component upon receipt of the indication.

2. The system of claim 1, wherein a location of the at least one temperature sensor on the outer surface of the housing is determined using a calculated thermal path from an initiation site of a failure to the outer surface of the housing.

3. The system of claim 2, wherein the calculated thermal path is determined using a model of the rotating component.

4. The system of claim 3, wherein the model of the rotating component is a finite element model.

5. The system of claim 4, wherein the location of the at least one temperature sensor is further determined using a thermal analysis of the finite element model.

6. The system of claim 1, wherein the at least one temperature sensor is a thermal switch that opens upon detection of a temperature greater than the selected temperature.

7. The system of claim 1, wherein the at least one temperature sensor comprises two thermal switches.

8. The system of claim 1, wherein the rotating component is a motor driven compressor (MDC).

9. The system of claim 1, wherein the selected temperature is approximately 435° F.

10. A method of monitoring a rotating component in a fuel-vapor zone, the method comprising:
monitoring a surface temperature of a housing of the rotating component using at least one temperature sensor;
indicating to a controller if the surface temperature of the housing reaches a selected temperature; and
terminating operation of the rotating component if the surface temperature of the housing of the component reaches the selected temperature.

11. The method of claim 10, wherein the at least one temperature sensor is a thermal switch that opens when the surface of the component reaches the selected temperature.

12. The method of claim 10, wherein the rotating component is a motor driven compressor (MDC).

13. The method of claim 10, wherein the selected temperature is approximately 435° F.

14. A method of determining a location for at least one temperature sensor on a rotating component in a fuel-vapor zone, the method comprising:
determining at least one failure location within the rotating component;
calculating a thermal path from the at least one failure location to an outer surface of a housing of the rotating component using a housing model; and
placing the at least one temperature sensor on the surface of the component at a location based upon the thermal path.

15. The method of claim 14, wherein the housing model is a finite element model.

16. The method of claim 15, wherein calculating the thermal path further comprises performing a thermal analysis on the finite element model using computational fluid dynamics.

17. The method of claim 14, wherein the rotating component is a motor driven compressor (MDC).
